(19) United States
(12) Patent Application Publication
(10) Pub. No.: US 2016/0366539 A1
(43) Pub. Date: Dec. 15, 2016

(54) EXCHANGING A FIRST SHORT-RANGE WIRELESS COMMUNICATION LINK FOR A SECOND SHORT-RANGE WIRELESS COMMUNICATION LINK IN A VEHICLE

(71) Applicant: GM Global Technology Operations LLC, Detroit, MI (US)

(72) Inventors: Lakshmi V. THANAYANKIZIL, Rochester Hills, MI (US); Robert A. HRABAK, West Bloomfield, MI (US)

(21) Appl. No.: 14/739,593

(22) Filed: Jun. 15, 2015

(51) Int. Cl. H04W 4/00; H04L 29/08; H04W 76/06; H04W 76/02

(52) U.S. Cl. CPC H04W 4/008; H04W 76/023; H04L 67/12; H04W 76/06

(57) ABSTRACT

A communication system that includes a vehicle and a mobile device, and a method of indicating to a mobile device an availability to hand-over a first short-range wireless communication (SRWC) link for a second SRWC link, which is carried out using the communication system. The method includes the steps of: establishing the first SRWC link between the mobile device and a first wireless hotspot device; providing wireless hotspot data to the mobile device using the first SRWC link; discovering a second wireless hotspot device using the first wireless hotspot device; determining whether credentials of the second wireless hotspot device are known to the first wireless hotspot device or the mobile device; and when the credentials are known, providing an indication to the mobile device of the availability of the second SRWC link via the first SRWC link.

### TECHNICAL FIELD

The present invention relates to exchanging a short-range wireless communication hotspot link between a vehicle device and a mobile device for another short-range wireless communication hotspot link between an extra-vehicle device and the mobile device.

### BACKGROUND

Newer vehicles with embedded cellular equipment have the capability to turn the vehicle into a roaming wireless hotspot. Vehicle passengers thereby utilize these wireless hotspot services with various portable or hand-held devices such as a smart phone. This enables a wireless service provider (WSP) account associated with the smart phone to avoid additional data charges. However, data charges are accrued on the WSP account associated with the embedded vehicle cellular equipment.

Once the smart phone connects to the vehicle hotspot (such as a Wi-Fi network), the smart phone will ceasing looking for other available wireless hotspots. From the point of view of the smart phone, there is no need to do so—provided the connection with the vehicle equipment remains intact. Generally, this is desirable; however, in some circumstances, other wireless hotspot networks may be available and connecting to these other hotspots would minimize the charges on the WSP account associated with the embedded vehicle cellular equipment. Thus, there is a need to enable the smart phone to disconnect from the vehicle equipment and subsequently connect to a newly discovered extra-vehicle hotspot network, and do so seamlessly.

### SUMMARY

According to an embodiment of the invention, there is provided a method of indicating to a mobile device an availability to hand-over a first short-range wireless communication (SRWC) link for a second SRWC link. The method includes the steps of: establishing the first SRWC link between the mobile device and a first wireless hotspot device; providing wireless hotspot data to the mobile device using the first SRWC link; discovering a second wireless hotspot device using the first wireless hotspot device; determining whether credentials of the second wireless hotspot device are known to the first wireless hotspot device or the mobile device; and when the credentials are known, providing an indication to the mobile device of the availability of the second SRWC link via the first SRWC link

According to another embodiment of the invention, there is provided a method of handing-over a first short-range wireless communication (SRWC) link between a head unit in a vehicle and a mobile device for a second SRWC link between SRWC equipment located external to the vehicle and the mobile device. The method includes the steps of: establishing the first SRWC link between the mobile device and the vehicle head unit; receiving wireless hotspot data from the head unit over the first SRWC link at the mobile device; receiving an indication from the head unit of an available second SRWC link with the SRWC equipment; determining whether establishing the second SRWC link is consistent with policy instructions of the mobile device; and when establishing the second SRWC link is consistent with policy instructions of the mobile device, disconnecting from the head unit and connecting with the SRWC equipment via the second SRWC link.

According to another embodiment of the invention, there is provided a method of commanding a mobile device to exchange a first short-range wireless communication (SRWC) link for a second SRWC link. The method includes the steps of: establishing the first SRWC link between the mobile device and a first wireless hotspot device; providing wireless hotspot data to the mobile device over the first SRWC link; discovering a second wireless hotspot device using the first wireless hotspot device; determining whether policy instructions stored on the mobile device indicate whether the mobile device should disconnect from the first wireless hotspot device and connect to the second wireless hotspot device; and when the policy instructions indicate that the mobile device should disconnect from the first wireless hotspot device and connect to the second wireless hotspot device, providing a command to the mobile device to disconnect from the first wireless hotspot device and connect to the second wireless hotspot device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow diagram of a method of exchanging a short-range wireless communication (SRWC) hotspot link between a vehicle device and a mobile device for another SRWC hotspot link between the mobile device and an extra-vehicle device.

### DETAILED DESCRIPTION OF THE ILLUSTRATED EMBODIMENT(S)

The method described below enables a vehicle user to minimize cellular data usage while providing wireless hotspot services to the user of a mobile device in or near the vehicle. For example, a vehicle telematics unit may establish a cellular link with a wireless carrier system, and a wireless hotpot can be created that utilizes the cellular link to provide the mobile device access to the internet, remote servers, etc. The electronic device in the vehicle that provides the wireless hotspot services may be the telematics unit itself, or another device coupled thereto such as a vehicle head unit. Thus, a mobile device in the vehicle can connect to the wireless hotspot via a short-range wireless communication (SRWC) link and thereby send and receive data. Once the mobile device is connected to, e.g., the vehicle head unit, the mobile device will not attempt to discover other nearby wireless hotspot networks unless the connected SRWC link (e.g., of the vehicle head) fails. Even then, according to protocol, the mobile device will make several attempts to re-connect to the vehicle SRWC link. Only after a number of failures to re-connect to the vehicle head unit will the mobile device attempt to discover another nearby wireless hotspot network. Of course, following a connection procedure with a second wireless hotspot device, the mobile device can resume sending and receiving data; however, the stoppage or interruption in data communication is not seamless, and in some instances, may require the vehicle user to provide credentials to the second wireless hotspot device before resuming communication. The method described herein enables a seamless transition to the second wireless hotspot device when the second wireless hotspot device is available and is determined to be a trusted source. This allows the vehicle user of the mobile device to mitigate costs associated with the cellular data (which makes possible the vehicle wireless hotspot services) and to seamlessly hand-over or transition from the wireless hotspot of the head unit to the second wireless hotspot device providing a more desirable user experience.

### Communications System—

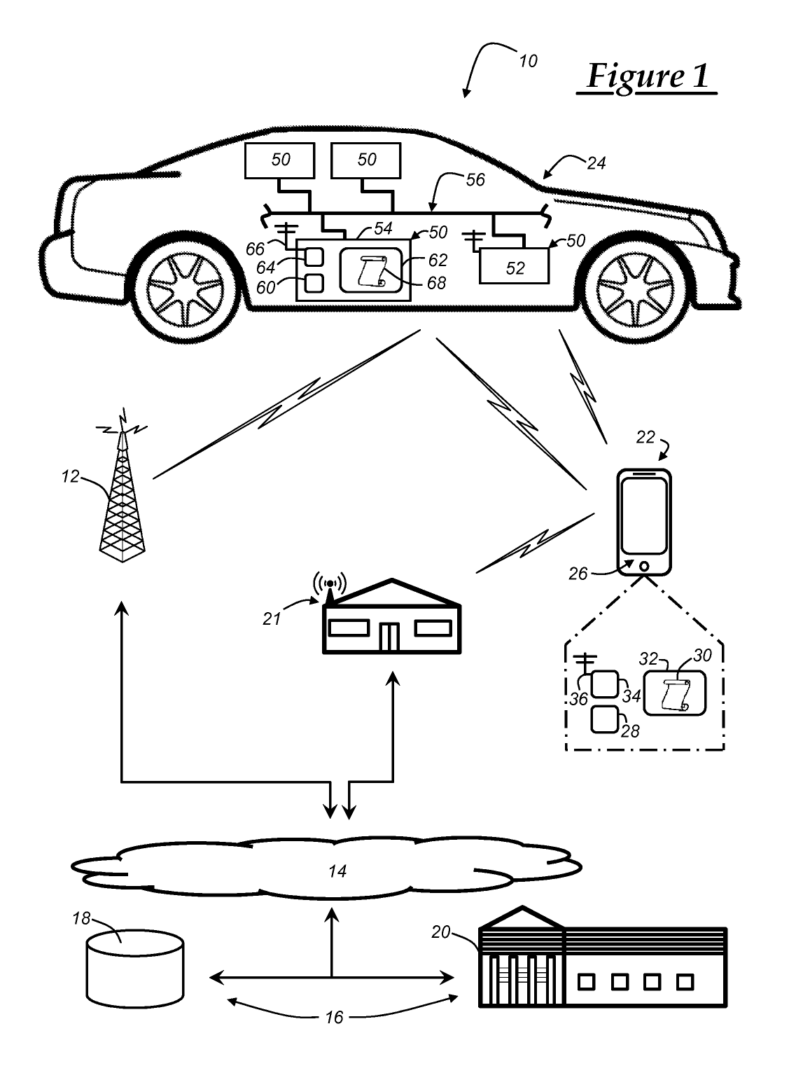

With reference to FIG. 1, there is shown an operating environment that comprises a mobile vehicle communications system 10 and that can be used to implement the method disclosed herein. Communications system 10 generally includes: one or more wireless carrier systems 12; a land communications network 14; a backend system 16 that includes at least one of a remote server 18 or a data service center 20; secondary short-range wireless communication (SRWC) equipment 21; a mobile device 22; and a vehicle 24. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Wireless carrier system 12 is preferably a cellular telephone system that includes a plurality of cell towers (only is one shown), one or more mobile switching centers (MSCs) (not shown), as well as any other networking components required to connect wireless carrier system 12 with land network 14. Each cell tower includes sending and receiving antennas and a base station, with the base stations from different cell towers being connected to the MSC either directly or via intermediary equipment such as a base station controller. Cellular system 12 can implement any suitable communications technology, including for example, analog technologies such as AMPS, or the newer digital technologies such as LTE, CDMA (e.g., CDMA2000) or GSM/GPRS. As will be appreciated by those skilled in the art, various cell tower/base station/MSC arrangements are possible and could be used with wireless system 12. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 12, a different wireless carrier system in the form of satellite communication can be used to provide uni-directional or bi-directional communication with the vehicle. This can be done using one or more communication satellites and an uplink transmitting station. Uni-directional communication can be, for example, satellite radio services, wherein programming content (news, music, etc.) is received by transmitting station, packaged for upload, and then sent to the satellite, which broadcasts the programming to subscribers. Bi-directional communication can be, for example, satellite telephony services using satellite to relay telephone communications between the vehicle 24 and uplink transmitting station. If used, this satellite telephony can be utilized either in addition to or in lieu of wireless carrier system 12.

Land network 14 may be a conventional land-based telecommunications network that is connected to one or more landline telephones and connects wireless carrier system 12 to backend system 16. For example, land network 14 may include a public switched telephone network (PSTN) such as that used to provide hardwired telephony, packet-switched data communications, and the Internet infrastructure. One or more segments of land network 14 could be implemented through the use of a standard wired network, a fiber or other optical network, a cable network, power lines, other wireless networks such as wireless local area networks (WLANs), or networks providing broadband wireless access (BWA), or any combination thereof. Furthermore, data service center 20 need not be connected via land network 14, but could include wireless telephony equipment so that it can communicate directly with a wireless network, such as wireless carrier system 12.

Remote server 18 can be one of a number of computers accessible via a private or public network such as the Internet. Each such server 18 can be used for one or more purposes, such as a web server accessible via land network 14 and/or wireless carrier 12. Other such accessible servers 18 can be, for example: a service center computer where diagnostic information and other vehicle data can be uploaded from the vehicle 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 24 or data service center 20, or both. Remote server 18 can also be used for providing Internet connectivity such as DNS services or as a network address server that uses DHCP or other suitable protocol to assign an IP address to the vehicle 24.

Data service center 20 is designed to provide the vehicle 24 with a number of different system back-end functions and generally includes one or more switches, servers, databases, live advisors, as well as an automated voice response system (VRS), all of which are known in the art. These various data service center components are preferably coupled to one another via a wired or wireless local area network. Switch, which can be a private branch exchange (PBX) switch, routes incoming signals so that voice transmissions are usually sent to either the live adviser by regular phone or to the automated voice response system using VoIP. The live advisor phone can also use VoIP; VoIP and other data communication through the switch may be implemented via a modem connected between the switch and network. Data transmissions are passed via the modem to server and/or database. Database can store account information such as subscriber authentication information, vehicle identifiers, profile records, behavioral patterns, and other pertinent subscriber information. Data transmissions may also be conducted by wireless systems, such as 802.11x, GPRS, and the like. Although one embodiment has been described as it would be used in conjunction with a manned data service center 20 using a live advisor, it will be appreciated that the data service center can instead utilize VRS as an automated advisor or, a combination of VRS and a live advisor can be used.

Secondary short-range wireless communication (SRWC) equipment or device 21 represents any electronic device capable of providing SRWC services that is not in vehicle 24. Equipment 21 includes any processing devices, memory, electronic transceivers or chipsets, etc. needed to provide a short-range wireless signal and communicate with mobile device 22 and/or vehicle 24. According to at least one embodiment, equipment 21 acts as a server-type device providing a wireless hotspot network or services to vehicle 24 and/or mobile device 22. As will be discussed in greater detail below, equipment 21 may require security credentials and be capable of validating or authenticating the credentials provided to it before allowing a client-type device to join the wireless hotspot network. Non-limiting examples of wireless hotspot networks provided by SRWC equipment 21 include wireless hotspot networks broadcasted by residential properties, businesses or commercial entities, and even mobile electronics.

Mobile device 22 may be any electronic device capable of cellular voice and/or data calls across a wide geographic area where transmissions are facilitated by the wireless carrier system 12. It may be configured to provide cellular services according to a subscription agreement with a third-party facility such as a wireless service provider (WSP). In addition, mobile device 22 may be electronically coupled to the vehicle 24 by wire (e.g., USB) or wirelessly via short-range wireless communication (SRWC) (e.g., Wi-Fi, Wi-Fi Direct, Bluetooth, etc.).

Mobile device 22 includes a user input/output (I/O) interface 26 which may include one or more switches or pushbuttons and a display. In some implementations, the display may be a touch screen or include other interactive features. The mobile device 22 further comprises one or more processors 28 configured to execute an operating system (OS) and one or more software applications 30 stored on mobile device memory 32. Applications may enable the user to remotely lock/unlock vehicle doors, turn the vehicle on/off, check the vehicle tire pressures, fuel level, oil life, etc. According to one embodiment, application 30 may be configured to act according to policy instructions stored in memory 32—thus, as will be described below, application 30 may perform at least some of the method steps described herein.

Processor 28 can be any type of device capable of processing electronic instructions including microprocessors, microcontrollers, host processors, controllers, vehicle communication processors, and application specific integrated circuits (ASICs). Processor 28 executes various types of digitally-stored instructions, such as software or firmware programs stored in memory 32, which enable mobile device 22 to execute a number of functions and/or applications. For instance, processor 28 can execute programs or process data and instructions to carry out at least a part of the method discussed herein.

The memory 32 may include any suitable non-transitory computer usable or readable medium computer, which include one or more storage devices or articles. Exemplary non-transitory computer usable storage devices include conventional computer system RAM (random access memory), ROM (read only memory), and EPROM (erasable, programmable ROM), EEPROM (electrically erasable, programmable ROM).

In addition to processor 30 and memory 32, the mobile device may include a short range wireless communication (SRWC) transceiver 34 and associated antenna 36 to support SRWC communications. These communications may be according to a peer-to-peer connection, a client-server connections, etc. According to at least one embodiment, the mobile device 22 is capable of discovering a nearby Wi-Fi wireless hotspot network, joining the network, and becoming a client-type device within the network (e.g., to a server or host-type device providing the Wi-Fi hotspot signal).

Non-limiting examples of the mobile device 22 include a cellular telephone, a personal digital assistant (PDA), a Smart phone, a personal laptop computer or tablet computer having two-way communication capabilities, a netbook computer, a notebook computer, or any suitable combinations thereof. The mobile device 22 may be used inside or outside of vehicle 24 by a vehicle user who may be a vehicle driver or passenger. It should be appreciated that the user does not need to have ownership of the mobile device 22 or the vehicle 24 (e.g., the vehicle user may be an owner or a licensee of either or both).

Vehicle 24 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Vehicle 24 may include electronics (some not shown) such as a microphone, one or more pushbuttons or other control inputs, a visual display, various vehicle sensors, and a number of vehicle system modules (VSMs) 50. In some implementations, the VSMs 50 of vehicle 24 include a telematics unit 52 and a head unit 54. Some of the electronics can be connected directly to the VSMs 50 such as, for example, the microphone and pushbutton(s), whereas others may be indirectly connected using one or more communication network connections 56.

Communication network connection 56 includes any wired or wireless intra-vehicle communications system for connecting or coupling the VSMs 50 and vehicle electronics to one another. According to one embodiment, the network connection 56 comprises a communications bus and/or an entertainment bus. Examples of suitable wired network connections include a controller area network (CAN), a media oriented system transfer (MOST), a local interconnection network (LIN), a local area network (LAN), and other appropriate connections such as Ethernet, Audio-Visual Bridging (AVB), or others that conform with known ISO, SAE and IEEE standards and specifications, to name but a few.

Telematics unit 52 can be an OEM-installed (embedded) or aftermarket device that is installed in the vehicle and that enables wireless voice and/or data communication over wireless carrier system 12 and via wireless networking This enables the vehicle 24 to communicate with data service center 20, other telematics-enabled vehicles (not shown), or some other entity or device (such as mobile device 22). The telematics unit preferably uses radio transmissions to establish a communications channel (a voice channel and/or a data channel) with wireless carrier system 12 so that voice and/or data transmissions can be sent and received over the channel. By providing both voice and data communication, telematics unit 52 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the data service center 20) and data communication (e.g., to provide GPS location data or vehicle diagnostic data to the data service center 20), the system can utilize a single call over a voice channel and switch as needed between voice and data transmission over the voice channel, and this can be done using techniques known to those skilled in the art. Cellular communication using the telematics unit 52 may be carried out over the wireless carrier system 12 using a wireless service provider (WSP); and it should be appreciated that the WSP associated with the telematics unit 52 need not be the same WSP associated with the mobile device 22.

According to one embodiment, telematics unit 52 utilizes cellular communication according to either GSM, CDMA, or LTE standards and thus includes a standard cellular chipset for voice communications like hands-free calling, a wireless modem for data transmission, an electronic processing device, one or more digital memory devices, and a dual antenna. It should be appreciated that the modem can either be implemented through software that is stored in the telematics unit and is executed by processor, or it can be a separate hardware component located internal or external to telematics unit 52. The modem can operate using any number of different standards or protocols such as LTE, EVDO, CDMA, GPRS, and EDGE. Wireless networking between the vehicle and other networked devices can also be carried out using telematics unit 52. For this purpose, telematics unit 52 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit 52 can be configured with a static IP address or can set up to automatically receive an assigned IP address from another device on the network such as a router or from a network address server.

Telematics unit 52 can be used to provide a diverse range of vehicle services that involve wireless communication to and/or from the vehicle. Such services include: turn-by-turn directions and other navigation-related services that are provided in conjunction with the GPS-based vehicle navigation module; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 52, but are simply an enumeration of some of the services that the telematics unit is capable of offering. Furthermore, it should be understood that at least some of the aforementioned modules could be implemented in the form of software instructions saved internal or external to telematics unit 52, they could be hardware components located internal or external to telematics unit 52, or they could be integrated and/or shared with each other or with other systems located throughout the vehicle, to cite but a few possibilities. In the event that the modules are implemented as VSMs 50 located external to telematics unit 52, they could utilize the network connection 56 (e.g., a vehicle bus) to exchange data and commands with the telematics unit.

Head unit 54 may be located in the center-stack module (CSM) or console of vehicle 24 and may comprise a user interface (not shown) for input/output (I/O). The user interface may include a graphics display, such as a touch-screen or a heads-up display and/or buttons or switches. The illustrated head unit 54 includes one or more processors or processing devices 60, one or more memory devices 62, a short range wireless communication (SRWC) chipset 64, and a SRWC antenna 66. Using the SRWC chipset 64 and antenna 66, the head unit 54 may connect with portable devices such as mobile device 22 (e.g., via Wi-Fi, Wi-Fi Direct, Bluetooth, etc.). This includes head unit 54 operating as a Wi-Fi wireless hotspot device; e.g., the telematics unit 52 may establish a data call using the wireless carrier system 12, connect to the internet, and provide internet data to the head unit 54 via the network connection 56. Having established the data connection, the head unit 54 may then broadcast a Wi-Fi wireless hotspot signal and permit access to wireless hotspot services for devices such as mobile device 22. In some instances, the mobile device 22 may be required to provide security credentials to the head unit 54, which the head unit may decrypt (if necessary) and compare received credentials to those stored credentials in memory 62 before authorizing access.

Processor 60 can be any type of device capable of processing electronic instructions including microprocessors, microcontrollers, host processors, controllers, vehicle communication processors, and application specific integrated circuits (ASICs). Processor 60 executes various types of digitally-stored instructions, such as software or firmware programs stored in memory 62 (e.g., such as application 68). According to one implementation, when application 68 is executed by processor 60, head unit 54 may act as a server-type device providing wireless hotspot services to mobile device 22 while also acting as a client-type device seeking other available wireless hotspot networks. Further, once another available wireless hotspot network is discovered by head unit 54, processor 60 (using application 68) may determine whether mobile device 22 has the credentials of the other hotspot network and/or whether the mobile device desires to connect to it. According to some embodiments, the instructions of application 68 may have the head unit 54 notify the mobile device 22 as to the availability of the new wireless hotspot network so that the mobile device can disconnect from the head unit wireless hotspot network. Or alternatively, the instructions of application 68 may have head unit 54 command the mobile device 22 to disconnect from the head unit wireless hotspot network and then join the newly discovered wireless hotspot network. In each of the implementations, the instructions of the application 68 may provide for a seamless hand-over from the head unit wireless hotspot network to the new/other wireless hotspot network. In at least one implementation, application 68 on head unit 54 complements application 30 on mobile device 22 to accomplish at least some of the steps of the methods described herein.

The memory 62 may include any suitable non-transitory computer usable or readable medium computer, which include one or more storage devices or articles. Exemplary non-transitory computer usable storage devices include conventional computer system RAM (random access memory), ROM (read only memory), and EPROM (erasable, programmable ROM), EEPROM (electrically erasable, programmable ROM).

Other VSMs 50 such as a GPS module can receive radio signals from a constellation of GPS satellites. From these signals, the module can determine vehicle position that is used for providing navigation and other position-related services to the vehicle driver. Navigation information can be presented on a vehicle display or can be presented verbally such as is done when supplying turn-by-turn navigation. The navigation services can be provided using a dedicated in-vehicle navigation module (which can be part of GPS module), or some or all navigation services can be done via telematics unit 52, wherein the position information is sent to a remote location for purposes of providing the vehicle with navigation maps, map annotations (points of interest, restaurants, etc.), route calculations, and the like. The position information can be supplied to data service center 20 or other remote computer system, such as computer 18, for other purposes, such as fleet management. Also, new or updated map data can be downloaded to the GPS module from the data service center 20 via the telematics unit 52.

Audio system may include or be coupled to a vehicle user interface and various electronics such as one or more microphones, pushbuttons, and display(s). As used herein, the term ‘vehicle user interface’ broadly includes any suitable form of electronic device, including both hardware and software components, which is located on the vehicle and enables a vehicle user to communicate with or through a component of the vehicle. Microphone provides audio input to the telematics unit 52 to enable the driver or other occupant to provide voice commands and carry out hands-free calling via the wireless carrier system 12. For this purpose, it can be connected to an on-board automated voice processing unit utilizing human-machine interface (HMI) technology known in the art. The pushbutton(s) allow manual user input into the telematics unit 52 to initiate wireless telephone calls and provide other data, response, or control input. Separate pushbuttons can be used for initiating emergency calls versus regular service assistance calls to the data service center 20. Audio system provides audio output to a vehicle occupant and can be a dedicated, stand-alone system or part of the primary vehicle audio system. According to the particular embodiment shown here, audio system is operatively coupled to one or more network connections 56 (e.g., for purposes of communication, entertainment, and the like) and can provide AM, FM and satellite radio, CD, DVD and other multimedia functionality. This functionality can be provided in conjunction with or independent of the head unit 54 described above.

Apart from the audio system and GPS module, the vehicle 24 can include other vehicle system modules (VSMs) 50 in the form of electronic hardware components that are located throughout the vehicle and typically receive input from one or more sensors and use the sensed input to perform diagnostic, monitoring, control, reporting and/or other functions. Each of the VSMs 50 is coupled by network connection 56 (e.g., a data bus) to the other VSMs, as well as to the telematics unit 52, and can be programmed to run vehicle system and subsystem diagnostic tests. As examples, other VSMs 50 may be an engine control module (ECM) that controls various aspects of engine operation such as fuel ignition and ignition timing, another VSM 50 can be a powertrain control module that regulates operation of one or more components of the vehicle powertrain, and another VSM 50 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle.

As will be appreciated by those skilled in the art, the above-mentioned VSMs 50 are only examples of some of the modules that may be used in vehicle 24. Other implementations are also possible.

### Method—

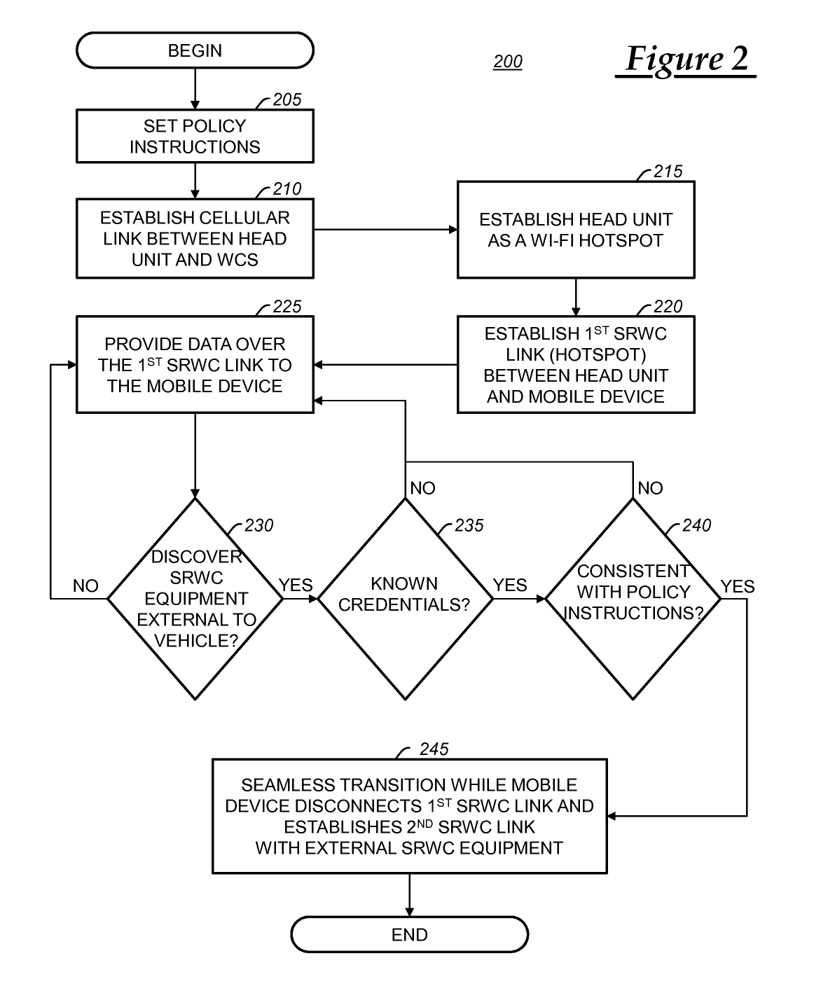

Turning now to FIG. 2, a method 200 is shown for exchanging or handing-over a first SRWC hotspot link between head unit 54 and mobile device 22 for a second SRWC hotspot link between extra-vehicle SRWC equipment 21 and the mobile device 22. The method begins with step 205. In step 205, policy rules or instructions of mobile device 22 are set.

As used herein, policy instructions include any predetermined or preconfigured settings or instructions stored in mobile device memory 32 indicating whether the mobile device should or should not join one or more wireless hotspot networks. Thus, the policy instructions may include an enumerated list of specific wireless hotspot networks or wireless hotspot devices or equipment to which the mobile device is permitted to connect, and/or an enumerated list of specific wireless hotspot networks or wireless hotspot devices or equipment to which the mobile device is not permitted to connect. Further, the policy instructions may include one or more constraints as well, which may be used to determine whether a wireless hotspot network is suitable to join. By way of example only, constraints can include: the name of the hotspot network; the type of hotspot network (e.g., whether it is secure or unsecured, or whether it is associated with a residence or commercial establishment); the strength of the hotspot network signal, the duration a hotspot signal must be detected before joining, a day(s) of the week or time(s) of day when joining is permissible or not permissible, etc. The policy instructions may be set by the vehicle user (or mobile device user) and may be changeable at later time. Or the policy instructions could be set by any authorized personnel, such as by the data service center 20 or a data service center advisor. In some instances, policy instructions may be set preliminarily using application software 30 stored on mobile device 22. These may be default instructions which may or may not (in some cases) be overridden. In at least one implementation, policy instructions include a WHEN-THEN instruction that states that WHEN the mobile device 22 is connected to a wireless hotspot network provided by vehicle head unit 54, THEN it should disconnect from head unit 54 in the event head unit 54 notifies it (the mobile device) of another available wireless hotspot network, provided the newly available wireless hotspot network meets any other defined policy instructions. In at least one other implementation, policy instructions include another WHEN-THEN instruction that states that WHEN the mobile device 22 is connected to a wireless hotspot network provided by vehicle head unit 54, THEN it should disconnect from head unit 54 in the event head unit 54 commands it (the mobile device) to disconnect therefrom and to then connect with a different wireless hotspot network. The different wireless hotspot network may or may not be identified to mobile device 22 prior to the disconnection from head unit 54.

Thus, in step 205, the policy instructions are set at least once before proceeding to step 210—whether it be according to default instructions or those set by the vehicle user or data service center. The method then proceeds to step 210.

In step 210, a cellular link is established between head unit 54 and wireless carrier system (WCS) 12. This may occur in a variety of ways. According to at least one embodiment, the telematics unit 52 establishes a data call using the WCS 12 enabling data communication with vehicle 24. Any data communicated to the telematics unit 52 may be transmitted to head unit 54 via vehicle bus 56. Thus, head unit 54 may be linked to the internet, various servers, etc. After establishing the cellular link, method 200 proceeds to step 215.

In step 215, head unit 54 is establishes a wireless hotspot network (e.g., a Wi-Fi hotspot network). This includes head unit 54 being connected to telematics unit 52 to send and receive data from vehicle 24, as well as providing a Wi-Fi signal within or near the vehicle. Any suitable technique may be used to establish the Wi-Fi wireless hotspot network; such techniques are known to skilled artisans and will not be elaborated here. Following step 215, the method proceeds to step 220.

In step 220, a first short-range wireless communication (SRWC) link is established—between head unit 54 and mobile device 22; i.e., the two devices are wirelessly coupled or connected. The first SRWC link enables mobile device 22 to communicate over the internet, the world-wide web, with remote servers, etc. In some instances, step 220 may include head unit 54 receiving credentials from mobile device 22 prior to establishing the first SRWC link. Credentials include any password, code, key, etc. to validate that the mobile device 22 is authorized establish the SRWC link. In some embodiments, these credentials are stored on memory 32 and accessible via application 30 (on the mobile device). Other implementations also exist, including performing step 220 without credentials. Following step 220, method 200 proceeds to step 225.

In step 225, the mobile device sends and receives data using the first SRWC link; e.g., by sending and/or receiving data to/from the internet, the world-wide web, remote servers, etc. This may include data pertaining to vehicle user e-mail, entertainment data such as music or video streaming, etc. These are merely examples, and sending and/or receiving data should be construed broadly. Following step 225, the method proceeds to step 230.

In step 230, head unit 34 determines whether extra-vehicle equipment 21 has been discovered. In making this determination, head unit 54 may behave as a server device and a client device. For example, as a server device, head unit 54 provides wireless hotspot data over the first SRWC link to mobile device 22 (the mobile device behaves as a client device). As a client device, head unit 54 seeks to discover or otherwise looks for the presence of other wireless hotspot networks or signals, such as that provided by equipment 21. Thus, if in step 230, head unit 54 discovers equipment 21 (or its wireless hotspot network), method 200 proceeds to step 235. However, if in step 230, head unit 54 does not discover equipment 21, the method returns or loops back to step 225. Steps 225 and 230 may be repeated, as necessary—e.g., until equipment 21 is discovered.

In step 235, head unit 54 determines whether the credentials needed to access the wireless hotspot associated with equipment 21 are known—e.g., to either it (device 54) or to mobile device 22. These credentials may be different from the credentials associated with head unit 54. For example, according to one embodiment, head unit 54 may check whether the credentials of equipment 21 are stored in head unit memory 62 or any other vehicle memory (e.g., memory of other devices or VSMs such as telematics unit memory). Or head unit 54 may send an inquiry (via the first SRWC link) to mobile device 22 for the credentials. In some implementations, application 68 (at head unit 54) inquires of mobile device 22 from time to time for shared-credentials; i.e., credentials which the application 30 on the mobile device is configured to share with the head unit. These shared-credentials are then stored in head unit memory 62 and used in step 235. If the credentials are known, the method proceeds to step 240. However, if the credentials are not known, method 200 again loops back to step 225. In looping back, steps 225, 230, and 235 may be repeated as necessary.

In step 240, it is determined whether establishing a second SRWC link between the mobile device 22 and equipment 21 is consistent with the policy instructions of mobile device 22. In one embodiment, the head unit 54 may send an inquiry (via the first SRWC link) to mobile device 22 to determine whether the policy instructions indicate that the mobile device 22 should establish the connection via the second SRWC link. Thus, mobile device 22 may provide the suitable policy instruction to head unit 54 enabling head unit 54 to make the determination in step 240. In other embodiments, the mobile device 22 makes the determination. For example, head unit 54 may inquire of mobile device, providing mobile device 22 information about the new wireless network and equipment 21. Then based on this information, mobile device 22 may determine whether or not to join. Regardless, in step 240, it is determined whether the policy instructions are consistent with joining the second SRWC or not. Thus in step 240, if an inconsistency with policy instructions is determined, then method 200 loops back again to step 225 (and steps 225, 230, 235, and 240 may be repeated as necessary). However if in step 240, a consistency with policy instructions is determined, the method proceeds to step 245.

In step 245, mobile device 22 disconnects from head unit 54 (i.e., the first SRWC link is terminated), and the mobile device connects to the equipment 21 (i.e., the second SRWC link is established). As will be explained in more detail below, this hand-over occurs seamlessly. According to one embodiment, step 245 includes mobile device receiving a notification or message from head unit 54 indicating that another wireless hotspot network is available via the first SRWC link (i.e., that a wireless hotspot network associated with equipment 21 is available). Application 68 (at head unit 54) may instruct the processor 60 and chipset 64 to send the message. In response, the mobile device disconnects the first SRWC link and establishes the second SRWC link, according to instructions of application 30. In some instances, the message further may comprise information indicating that the head unit 54 has predetermined or otherwise pre-qualified mobile-device-connectivity equipment 21; e.g., the head unit 54 may verify that the credentials of equipment 21 are known to the mobile device 22 prior to sending the message.

In another embodiment, the head unit 54 commands the mobile device to perform step 245; i.e., to terminate the first SRWC link and establish the second SRWC link. For example, application 68 may include instructions to send a command to the mobile device 22 when a suitable external wireless network is available, and application 30 (and/or policy instructions on the mobile device) may be configured to obey the command sent from the head unit 54. In another embodiment, the application 30 (and/or policy instructions on the mobile device) may be configured to establish the second SRWC link in response to head unit 54 terminating the first SRWC link. These of course are merely examples, and other implementations also exist.

The disconnection from head unit 54 and subsequent connection to equipment 21 includes a seamless hand-over (or transition or exchange). As used herein, the term seamless hand-over includes switching from one SRWC link to another SRWC link without perceptible interruption in data transmission from the point of view of the vehicle user (who is also the mobile device user). Thus, according to at least one embodiment, the first and second SRWC links involved in the seamless hand-over are Wi-Fi hotspot network connections: (a) between the head unit 54 and mobile device 22; and (b) between equipment 21 and mobile device 22, respectively.

Thus, after the mobile device disconnects from the first SRWC link, seamless hand-over includes not requiring the mobile device user to manually enter credentials into the user interface 26 in order to gain access to the second SRWC link. For example, application 30 may be configured together with processor 28 to provide the credentials to equipment 21 without user interaction. Further, seamless hand-over excludes the mobile device 22 attempting to re-connect with the first SRWC link before establishing a connection with the second SRWC link. Re-connection attempts typically occur when an unexpected break or interruption in the SRWC link occurs; e.g., the mobile device makes a predetermined number of attempts to re-connect before attempting to discover other available wireless networks. In one embodiment discussed above, mobile device 22 performs the disconnection from head unit 54; thus, device 22 would not attempt to re-connect according to Wi-Fi protocol. However, in another embodiment discussed above, head unit 54 performs the disconnection from mobile device 22; data indicating the nature of the disconnection may be sent to the mobile device prior to the disconnection which can be processed using application 30 stored on the mobile device—and according to such instructions, mobile device 22 will not attempt to re-connect to head unit 54 in this circumstance. Following step 245, method 200 ends.

Other embodiments also exist. According to one implementation, data from one or more vehicle system modules (VSMs) 50 can be used to complement method 200. This may include data from the GPS module in the vehicle which may be used to identify and/or utilize previously-used wireless hotspot networks by global positioning coordinates. And hand-overs to previously trusted equipment 21 may occur. Or in another example, a control module in vehicle 24 which determines vehicle tire speed may be used to determine the timing of when or when not to attempt to discover local wireless hotspot networks. For example, when vehicle 24 is moving (or moving above a predetermined threshold), no discovery attempts may be made. These are merely examples. Other suitable VSM data may be used to perform one or more of the steps of method 200. In addition, application 30 may request this and other suitable VSM data from head unit 54 to determine whether the VSM data is consistent with policy instructions (step 240).

It should be appreciated that the head unit 54 was used to illustrate a vehicle device capable of performing the method 200 with the mobile device 22; however, other vehicle electronics also could be used instead, such as telematics unit 52 (which also may provide wireless hotspot services). In addition, more than one mobile device may carry out method 200 at the same time. According to the policy instructions stored on a first mobile device, it may carry out all of the steps of method 200; however, according to the policy instructions stored on a second mobile device, it may not. For example, the second mobile device may not carry out one or more of steps 230, 235, 240, or 245.

Thus, there has been described a communication system that includes a vehicle, a mobile device, and extra-vehicle wireless hotspot equipment. One or more methods may be carried out using the communication system that enable a seamless SRWC hand-over of a mobile device first connected to the vehicle via a first SRWC link and then connected to the equipment via a second SRWC link. Both the vehicle and the mobile device may have application software stored thereon which may carry out at least a portion of the method(s). The seamless hand-over enables a vehicle user to conserve cellular data that is needed to provide the first SRWC link by switching to an available and suitable second SRWC link external to the vehicle.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of indicating to a mobile device an availability to hand-over a first short-range wireless communication (SRWC) link for a second SRWC link, comprising the steps of:
establishing the first SRWC link between the mobile device and a first wireless hotspot device;
providing wireless hotspot data to the mobile device using the first SRWC link;
discovering a second wireless hotspot device using the first wireless hotspot device;
determining whether credentials of the second wireless hotspot device are known to the first wireless hotspot device or the mobile device; and
when the credentials are known, providing an indication to the mobile device of the availability of the second SRWC link via the first SRWC link.

2. The method of claim 1, wherein each of the first and second SRWC links are wireless hotspot links, wherein the first wireless hotspot device behaves as a first server device and the mobile device behaves as a client device and, if the mobile device connects to the second wireless hotspot device, the second wireless hotspot device behaves as a second server device and the mobile device behaves as the client device.

3. The method of claim 1, further comprising establishing a cellular link between the first wireless hotspot device and a wireless carrier system (WCS) prior to establishing the first SRWC link, wherein the wireless hotspot data is provided using the cellular link.

4. The method of claim 3, wherein the cellular link is established via a vehicle telematics unit.

5. The method of claim 1, further comprising receiving different credentials from the mobile device prior to providing wireless hotspot data to the mobile device over the first SRWC link.

6. The method of claim 1, wherein the first wireless hotspot device is a head unit in a vehicle.

7. The method of claim 6, wherein the second wireless hotspot device is short-range wireless communication (SRWC) equipment located external of the vehicle.

8. The method of claim 1, further comprising:
receiving a response from the mobile device after providing the indication to the mobile device; and
based on the response, disconnecting the first SRWC link so that the mobile device may connect with the second wireless hotspot device over the second SRWC link.

9. The method of claim 8, wherein the mobile device receives seamless wireless hotspot data during the disconnection from the first SRWC and subsequent connection to the second SRWC link.

10. A method of handing-over a first short-range wireless communication (SRWC) link between a head unit in a vehicle and a mobile device for a second SRWC link between SRWC equipment located external to the vehicle and the mobile device, comprising the steps of:
establishing the first SRWC link between the mobile device and the vehicle head unit;
receiving wireless hotspot data from the head unit over the first SRWC link at the mobile device;
receiving an indication from the head unit of an available second SRWC link with the SRWC equipment;
determining whether establishing the second SRWC link is consistent with policy instructions of the mobile device; and
when establishing the second SRWC link is consistent with policy instructions of the mobile device, disconnecting from the head unit and connecting with the SRWC equipment via the second SRWC link.

11. The method of claim 10, wherein the mobile device receives seamless wireless hotspot data during the disconnection from the head unit and the subsequent connection to the SRWC equipment.

12. The method of claim 10, wherein the policy instructions are stored on memory of the mobile device or on memory of the head unit.

13. The method of claim 10, wherein the first SRWC link is established based on credentials provided by the mobile device to the head unit.

14. The method of claim 10, wherein receiving the indication from the head unit of the available second SRWC link is based at least partially on the head unit verifying credentials with the SRWC equipment prior to providing the indication to the mobile device.

15. A method of commanding a mobile device to exchange a first short-range wireless communication (SRWC) link for a second SRWC link, comprising the steps of:
establishing the first SRWC link between the mobile device and a first wireless hotspot device;
providing wireless hotspot data to the mobile device over the first SRWC link;
discovering a second wireless hotspot device using the first wireless hotspot device;
determining whether policy instructions stored on the mobile device indicate whether the mobile device should disconnect from the first wireless hotspot device and connect to the second wireless hotspot device; and
when the policy instructions indicate that the mobile device should disconnect from the first wireless hotspot device and connect to the second wireless hotspot device, providing a command to the mobile device to disconnect from the first wireless hotspot device and connect to the second wireless hotspot device.

16. The method of claim 15, wherein the determining step includes sending an inquiry to the mobile device over the first SRWC link to determine the policy instruction with respect to the second wireless hotspot device, and receiving a response from the mobile device at the first wireless hotspot device, wherein the response indicates whether the mobile device will disconnect from the first wireless hotspot device and subsequently connect to the second wireless hotspot device.

17. The method of claim 15, wherein the first wireless hotspot device is a vehicle head unit, wherein the second wireless hotspot device is SRWC equipment located external from the vehicle.
